(19) United States
(12) Patent Application Publication
(10) Pub. No.: US 2026/0149751 A1
(43) Pub. Date: May 28, 2026

(54) ON-DEVICE MANAGEMENT OF COMPUTING COOKIE PLACEMENT FOR ENFORCEMENT OF USER CONSENTS

(71) Applicant: PAYPAL, INC., San Jose, CA (US)

(72) Inventor: Chetan Nadgire, Fremont, CA (US)

(21) Appl. No.: 18/959,416

(22) Filed: Nov. 25, 2024

(51) Int. Cl. H04L 67/146; G06F 9/54

(52) U.S. Cl. CPC H04L 67/146; G06F 9/547

(57) ABSTRACT

There are provided systems and methods for on-device management of computing cookie placement for enforcement of user consents. A service provider, including an electronic transaction processor, may provide consent management and enforcement through an on-device consent storage and library of user consents. When a device interacts with a website, such as one provided by a service provider, the device may utilize the on-device storage to lookup a user consent. The user consent may indicate allowable computer cookie placement and/or usage of computer cookies by the website with the device. The consent may be used to generate a data string or other file that may be transmitted to the website's server to convey the user's consent to the server. The data string may include one or more parameters for the user's consent. The data string may be attached to a network call made to the server for website data.

### TECHNICAL FIELD The present application generally relates to automated user consent enforcement and data privacy protection and more particularly to managing on-device website cookie placements.

### BACKGROUND

Service providers may have large computing systems and numerous services that provide automated interfaces and interactions with different end users, such as customers, clients, internal users and teams, and the like. Users may interact with various websites and their digital platforms via computing devices, which may include providing and/or sharing private data and/or privacy protected data, such as personally identifiable data (PII), know your customer (KYC) data, financial data, and the like that may be privacy protected and/or desirable to remain private or not be shared. Conventionally, tracking of this data and/or providing functionalities with the websites uses device and browser computer cookies, which correspond to data strings, tokenized data, identifiers, or the like, that are locally stored on a computing device when a login or authentication is successful. However, this requires device-side storage of data (e.g., a browser cookie) that may violate ever-increasingly stricter laws and regulations (e.g., General Data Protection Regulation (GDPR), California Consumer Privacy Act (CCPA), and the California Privacy Rights Act (CPRA) regulations). Thus, it is desirable for service providers to implement an automated system to manage consent authorizations and privacy protections without device-side data storage and through a more flexible consent management framework.

### BRIEF DESCRIPTION OF THE DRAWINGS

FIG. 1 is a block diagram of a networked system suitable for implementing the processes described herein, according to an embodiment;

FIGS. 2A-2D are exemplary diagrams of device-side components that generate data strings and attachments for network calls to website hosts for website data with cookie consent permissions, according to an embodiment;

FIGS. 3A and 3B are exemplary diagrams of server-side components that process network calls having data strings and attachments for cookie consent permissions, according to an embodiment;

FIG. 4 is a flowchart for on-device management of computing cookie placement for enforcement of user consents, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for on-device management of computing cookie placement for enforcement of user consents. Systems suitable for practicing methods of the present disclosure are also provided.

When using computing platforms and websites of service providers, the service provider may utilize computer cookies and other data files or components to enable certain functionalities with the website. For example, cookies may be stored device-side for authentication and subsequently used in order to reduce risk, fraud, and other misappropriation of data during login and/or authentication. After a user has used a particular device to authenticate and/or login to an account, a computer cookie may be stored locally to the device and/or associated with the device and application used for the authentication. This computer cookie may correspond to a data string, identifier, device fingerprint (e.g., based on device identifiers, operating system data or identifiers, applications, and the like), or other data that uniquely identifies the user's device, such that subsequent authentications may not be needed or may be reduced.

Other cookies may be used to track user data and/or provide marketing and advertising to users based on their input, interactions, search or browsing histories, and/or other historical and/or user data. Computer cookies may be used to track and/or determine PII, KYC, privacy protected, and other personal, financial, or private data. For example, such private user data may be entered or uploaded during an account establishment or update or maintenance phase, while processing transactions or interacting with various computing services, users, or entities, and/or communicated via different communication channels. Other cookies may enable core website functions and processes on or with the website, track website performance with devices, and/or provide additional functionalities for settings, preferences, and the like.

As such, according to various embodiments, a service provider may implement cookie management and data privacy operations that manage cookie transmission and/or placement on computing devices based on on-device user consents. The cookie management and data privacy operations may assist the service provider with complying with data privacy protections, laws, rules, and regulations. In this regard, when complying with data privacy regulations and user consent opt-in requirements, the service provider may be required to request consent and authorization to transmit, place, and/or store cookies for any number of reasons (e.g., for marketing, advertising, statistics and/or data research, authentication, website functionalities, website enhancement and personalization, etc.), as well as require a user consent for on-device cookie placement or on-device storage and/or use of other data files. Consents may include different permissions and parameters, and cookie placement may be opted-in within user configurable parameters, such as a type of cookie classification allowable for on-device placement, a length of permission of placement, who or where the cookie can be shared with, or other designation of the consent scope. Consent management may further require a process by which consent can be withdrawn by users.

As such, the on-device cookie management and user consent enforcement for on-device cookie placement may include a device-side storage and/or library of user consents that may be usable to determine cookie consent for different websites (e.g., parameters that may indicate the classifications and other types of cookies that are allowable to be placed on the computing device, including limitations on placement). The on-device consent storage may be used when a navigation to a website is detected in a browser on the computing device. The computing device may perform a lookup of the website and determine either specific user consents and their corresponding parameters for cookie placement, or a general consent if the website does not have an expressly set consent. The computing device may then generate, configure, and/or retrieve a data string or other data for an attachment that can be added and/or attached to a network call, such as an application programming interface (API) call over a network to a website server hosting the website, and may execute and transmit the network call to the website's server. The website server may then utilize a cookie management framework and storage system that enforces policies to comply with laws, regulations, and company rules or objectives governing privacy protection and computer cookie usage. The framework may then transmit computer cookies to and/or place computer cookies on the computing device in accordance with the consent indicated in the data string or other attachment to the network call, which may prevent cookies and corresponding data, as well as tracking of user data, from being placed, transmitted, or shared without user or proper consent.

Such cookies and corresponding data are used for various transactions through different entities and services provides. In one example, an online transaction processor may provide electronic transaction processing services, including account services, user authentication and verification, digital payments, risk analysis and compliance, and the like. A service provider, which may provide services to users including electronic transaction processing such as online transaction processors (e.g., PayPal®), may enable merchants, users, and other entities to process transactions, provide payments, provide content, and/or transfer funds between these users. The user may also interact with the service provider to establish an account and provide other information for the user. Other service providers may also or instead provide computing services, including social networking, microblogging, media sharing, messaging, business and consumer platforms, etc. Service providers may make these different computing services available through websites and other online platforms, which may utilize cookies for different purposes including website or platform functionality, customization, marketing, user tracking, and the like.

The computing services of a service provider may be availed through a user establishing an account with the service provider by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and the like. The user may also be required to provide financial information, including payment card (e.g., credit/debit card) information, bank account information, gift card information, benefits/incentives, and/or financial investments, which may be used to process transactions for items. The online service provider may provide digital wallet services through the account, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services.

As such, a user may engage in one or more online or virtual interactions with websites or applications of service providers, as well as other entities including merchants, social media platforms, businesses, news or information sources, and the like, for example by browsing websites and their available data. These interactions may require use of computer cookies to enable functionalities, as well as for different purposes, such as authentication and transaction processing. However, cookie placement on computing devices may be privacy protected by rule, law, policy, or regulation, and/or users may wish to protect such data. The data accessed, stored, and/or utilized by the service provider in association with cookies may include privacy protected data, such as PII, financial data, health data, transaction data and/or histories, KYC data, and the like.

As such, a more secure consent framework for management and enforcement of user consents, permissions, and authorizations for cookie placement may be provided through on-device management of user consents and consent parameters for consent opt-ins by users to cookie placement on their device. Initially, a user may engage with a browser application and/or browser application add-on or extension that may allow for the user to establish their consents for cookie placement and usage with their browser and computing device. A cookie manager tool or process may be used to establish the user's consents and permissions for on-device placement of data by websites including computer cookies and the like. These consents and permissions may include corresponding parameters, which may indicate the extent and/or allowable placement of the cookies and other data, such as a length of time, a type of cookie, a functionality of the cookie, and the like. For example, the parameters may be associated with classification of different cookies and/or cookie uses or functionalities, such as marketing cookies, functional cookies, tracking cookies, targeting cookies, performance cookies, authentication cookies, and the like. As such, the user may select websites, either individually or in groups by domain name, identifier, category, or other identifying information, as well as a general consent setting, and may specify parameters under which cookie placement and device-side use/storage is allowable including type of cookie, cookie functionality, length of placement, and/or other restrictions of cookie use or placement.

Once established, the user consents may be stored by an on-device consent storage and/or library, such as in a memory of the computing device. Thereafter, a navigation by the user to a website in a browser application and/or via a web browser may be detected. Note that “web browser” is used herein may refer to any service, module, or application that enables a user to navigate to a website, webpage, or application (collectively referred to herein as a website). When a navigation occurs, the browser application may utilize the address or other identifier of the website to perform a lookup of the user's consent for cookie placement in the consent storage and/or library. A data string may then be generated that may include data indicating the user's consent that, when processed by the website, may be used to convey the user's consent to the website and cause the website to provide or transmit computer cookies to the computing device of the user in accordance with the user's consent. As such, the data string may correspond to computer code or other language and information having fields for the consent parameters. The data string may be attached to a network call that may be made to the server of the website so that when the server is called for network data, the attached data string or other information may also be conveyed to the website's server.

The website's server may then receive the network call and identify that consent data has been attached to the network call. The consent data may be identified from the attachment, and the attached data string having the parameters for the user's consent to placement of browser cookies or other computer cookies on the computing device calling the server may be identified and/or extracted. The data string may be parsed to determine the consent data, for example, using the fields from the data string that include the parameters of the user's consent. Once those parameters and the user's consent are determined, the server may correlate that data to cookie classifications and other cookie classification and identification data, such as the different classes, uses, functionalities, and/or types of the browser cookies or other computing cookies.

The user's consent may be used to enforce cookie consent with the server and website once parsed and processed. In this regard, the cookie consent may be stored for future use with the computing device or may be used only for the current session between the computer device and the server/website. For example, a system of record (SOR) may correspond to one or more data tables of consent opt-ins and authorizations, corresponding consent parameters, user data and/or data records, and/or linked identifiers. An SOR may therefore store user consents or may not be required, and the consent may be deleted or erased after the current session. Using the consent and the correlation to cookie classification data, the server may then determine allowable browser or other computing cookies that may be transmitted to and/or placed on the user's computing device. The server may then transmit these to the user's device, which may store and/or allow use of the cookies. Further, the server may place and/or configure cookies to have a data field indicating attributes of the browser cookie, such as a classification of the browser cookie, as well as if the browser cookie is essential or nonessential for use with the website. The device may also revoke cookie consent, such as by transmitting one or more further calls, which request cookies are removed, forgotten, and/or no longer placed on the user's computing device.

Therefore, the service provider's system may provide an automated consent management and enforcement process, framework, and system designed to enforce user consents for cookie placements and other local or on-device storage of data without or independent of requiring a server and/or other computing system for the website storing and retaining the user consent. By providing a consent library and storage on-device for cookie placement management, a user may limit data exposure and risk of misappropriation of data. Additionally, the on-device storage and library for the device may be utilized cross-platform with multiple different websites and servers so that consent for cookie placement may be enforced without required user opt-ins with each website, thereby reducing manual inputs and erroneous consent opt-ins. This allows for faster, more efficient, more reliable, and more widely available consent enforcement for data privacy protection, while minimizing data storage by different website servers and storage systems. As such, consent enforcements may be enforced in a faster manner without requiring individual device lookups by servers when devices engage with their corresponding websites. Therefore, a service provider may implement an improved computing system, framework, and processes that provide more efficient, optimized, and secure consent enforcement for cookie usage and data privacy protections.

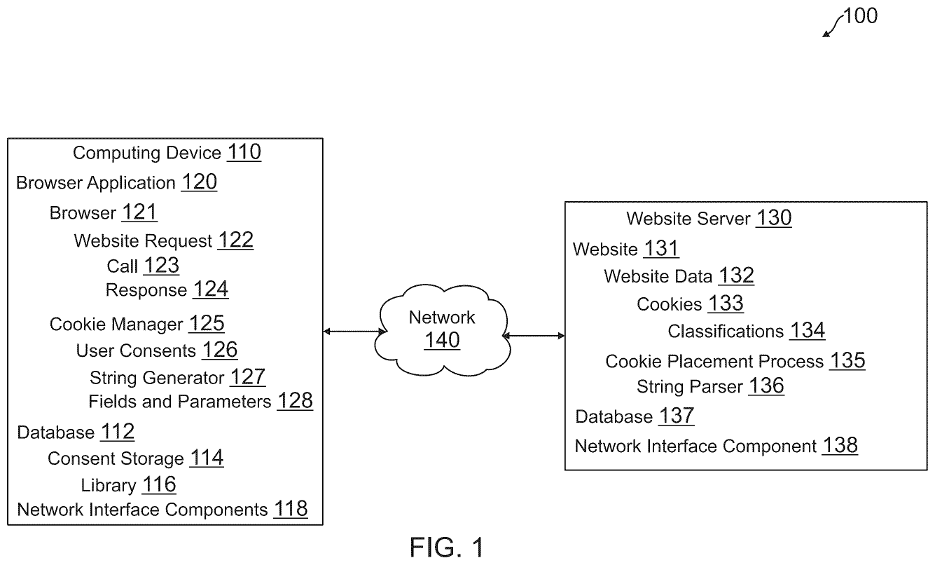

FIG. 1 is a block diagram of a networked system 100 suitable for implementing the processes described herein, according to an embodiment. As shown in FIG. 1, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a computing device 110 and a website server 130 in communication over a network 140. Computing device 110 may be utilized by a user, customer, or the like to access a website 131 for a computing service or resource provided by website server 130, which may be provided or accessible via one or more applications on computing device 110. Website server 130 may provide website 131 with various data, operations, and other functions to computing device 110 and/or other devices via network 140. In this regard, website server 130 may provide a data privacy and consent management and enforcement framework to manage browser and other computer cookie transmissions and placements on computing device 110 based on received user consents from consent data attached to network calls or other requests for user data or consents.

Computing device 110 and website server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Computing device 110 may be implemented as a communication device that may utilize appropriate hardware and software configured for wired and/or wireless communication with website server 130 and/or other devices and/or servers. For example, in one embodiment, computing device 110 may be implemented as a personal computer (PC), a smart phone, laptop/tablet computer, wristwatch with appropriate computer hardware resources, eyeglasses with appropriate computer hardware (e.g., GOOGLE GLASS ®), other type of wearable computing device, implantable communication devices, and/or other types of computing devices capable of transmitting and/or receiving data. Although only one device is shown, a plurality of devices may function similarly and/or be connected to provide the functionalities described herein.

Computing device 110 of FIG. 1 contains a browser application 120, a database 112, and a network interface component 118. Browser application 120 may correspond to executable processes, procedures, and/or applications with associated hardware. In other embodiments, computing device 110 may include additional or different modules having specialized hardware and/or software as required.

Browser application 120 may correspond to one or more processes to execute software modules and associated components of computing device 110 to provide features, services, and other operations for a user over network 140, which may include accessing and/or interacting with website 131 from website server 130. In this regard, browser application 120 may correspond to specialized software utilized by a user of computing device 110 that may be used to access website 131 or a user interface that may provide and/or output website 131 (e.g., a web view within a native software application) from website server 130. In various embodiments, browser application 120 may correspond to a general browser application having a browser 121 configured to retrieve, present, and communicate information over the Internet (e.g., utilize resources on the World Wide Web) or a private network. For example, browser application 120 may provide browser 121 to access websites and send/receive information for website 131 over network 140, including retrieving website data 132 (e.g., a website for a merchant), presenting website data 132 to the user, and/or communicating information to website 131. However, in other embodiments, browser application 120 may include a dedicated or native application of a service provider, merchant, or other entity associated with website server 130, where browser 121 may access website 131 through such software application.

Browser application 120 may be associated with account information, user financial information, and/or transaction histories, and may be used to process transactions and/or utilize payment and transaction processing services with website 131. However, in further embodiments, different services may be provided via browser application 120, including messaging, social networking, media posting or sharing, microblogging, data browsing and searching, online shopping, and other services available through website server 130.

When using browser application 120, a website request 122 may be used to request website data 132 so that website 131 may be rendered and output in browser 121. Website request 122 may be made in response to a user navigating to website 131, such as by selecting a link, entering a website address (e.g., a URL address, URI, etc.), or performing another action that causes browser 121 to navigate to and load website 131.

Website request 122 includes a call 123 for website data 132 that may allow loading, rendering, and output of website 131 in browser 121. However, when making call 123 to website server 130 over network 140, such as when executing an API call or other network call, a cookie manager 125 may append or attach consent data to call 123 so that a user consent to cookie transmission, placement, and/or usage with browser 121 may be provided to website server 130, thereby controlling which types of cookies are provided to and used with browser 121, as well as other extents on transmission, placement, and/or usage of, or data included with, the cookies.

In this regard, cookie manager 125 may access a consent storage 114 from database 112, which may correspond to a transitory or non-transitory storage component and/or memory having a library 116 of user consents for cookie placements. As such, library 116 may correspond to a consent library or other set of user consents opted-in to and/or set by the user corresponding to computing device 110. When website 131 is requested via website request 122, a lookup of website 131 may be performed from library 116 in consent storage 114 for user consents 126, and specifically one or more of user consents 126 for website 131. The lookup may be performed using a website identifier, address, domain name, or other information, and a user consent may be determined. The user consent from user consents 126 may be specific to website 131 and/or a set of websites including website 131 (e.g., identified as a group of websites by domain name/address/etc., by the type of the websites, content provided by the websites), or may be a general user consent for all websites and/or unspecified websites. The user consent may be as general or as specific as set, including consent to all websites for a certain type of cookie/data or consents based on website, type of cookie, etc.

Cookie manager 125 may then execute a string generator 127 to generate and/or configure/update a data string for an attachment to call 123 based on the determined user consent. To do so, string generator 127 may determine fields and parameters 128 for the fields of the data string and the parameters of the user consent, respectively. String generator 127 may generate or update one or more data fields from fields and parameters 128 for the data string with parameters of fields and parameters 128 indicating the user's consent, such as the classification of allowed cookies, length of time for allowance of cookie placement or user, and/or other limitation on the extent and/or usage of cookies with browser 121. The data string may then be attached to call 123 by cookie manager 125, such as by injecting and/or inserting in a header of a message for call 123 or otherwise attaching a data file or the like to call 123. Call 123 may then be executed and sent to website server 130. A response 124 may be received by browser 121, which may include a cookie having cookie data that may include a cookie classification. As such, cookie manager 125 may parse and process the cookie data to ensure that the cookie classification complies with the user consent.

In some embodiments, browser application 120 may be used to provide one or more interfaces to opt-in to consent and authorizations for cookies and cookie placements, as well as change, manage, and update such consents. Cookie manager 125 may provide one or more opt-in requests and/or authorizations for user consents 126, which may be stored with library 116 in consent storage 114. Consent storage 114 may correspond to an in-application storage and/or memory (e.g., a cache or other ephemeral storage), or may be stored in a more permanent manner with database 112. Cookie manager 125 may correspond to an in-application process or may instead correspond to an application or browser extension, add-on, or the like to control user consents and cookie placements.

Computing device 110 may further include database 112 stored on a transitory and/or non-transitory memory of computing device 110, which may store various applications and data and be utilized during execution of various modules of computing device 110. Database 112 may include, for example, identifiers such as operating system registry entries, cookies associated with browser application 120 and/or other applications, identifiers associated with hardware of computing device 110, or other appropriate identifiers, such as identifiers used for payment/user/device authentication or identification, which may be communicated as identifying the user/computing device 110 to website server 130. Database 112 may include consent storage 114 as a storage component for browser application 120 and/or accessible by browser application 120 for storage of user consents 126 in library 116 and/or access of user consents 126 for transmission to different websites and corresponding servers.

Computing device 110 includes at least one network interface component 118 adapted to communicate with website server 130 and/or other devices, servers, and endpoints. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Website server 130 may be maintained, for example, by an online service provider, which may provide web applications, data, and/or content accessible via a web or network address and used to serve or provide website 131 over network 140. In this regard, website server 130 includes one or more processing applications which may be configured to interact with computing device 110 and/or other internal and/or external computing services to provide and serve website 131. In one example, website server 130 may be provided by PAYPAL®, Inc. of San Jose, CA, USA. However, in other embodiments, website server 130 may be maintained by or include another type of service provider.

Website server 130 of FIG. 1 includes an application for website 131, a database 137, and a network interface component 138. The application for the website 131 on website server 130 may include executable processes, procedures, and/or modules with associated hardware used to provide a website over network 140 that may be accessible by various web browsers. In other embodiments, website server 130 may include additional or different modules having specialized hardware and/or software as required.

Website 131 may correspond to one or more online websites and associated resources to provide features, services, and other operations for hosting and serving website 131 over network 140, such as to computing device 110. As such, website 131 may provide website data 132 for information, computing services, products (e.g., items and/or services for sale), interactable features, and the like to users on one or more webpages. In some embodiments, website 131 may be hosted, provided by, and/or utilized by a merchant, seller, or the like to advertise, market, sell, and/or provide items or services for sale, as well as provide checkout and payment. In this regard, website 131 may be utilized by one or more merchants to provide websites and/or online portals for transaction processing and sales. For example, website 131 may be used to host a website having one or more webpages that may be used by customers to browse items for sale and generate a transaction for one or more items. Website 131 may provide a checkout process, which may be utilized to pay for a transaction. In some embodiments, the checkout process may be provided by an online transaction processor or other service provider based on one or more operations, software development kits (SDKs), API standards or guidelines, and the like that may be implemented in the merchant website. The checkout process may be used to pay for a transaction using a payment instrument, including a credit/debit card, and account with website server 130, or the like.

Website 131 may be utilized by customers and other end users to view one or more user interfaces, for example, via graphical user interfaces (GUIs) presented using an output display device of computing device 110. These user interfaces may be used to navigate through items for sale on the merchant website, generate a transaction, and checkout for the transaction on the merchant website. Other embodiments of website 131 may include those used for other online services, interactions, and/or information, including those used for messaging, social networking, media posting or sharing, microblogging, data browsing and searching, news, information streaming or uploading, and the like. Website data 132 may further include webpages of website 131 that provide features, services, and other operations through one or more sub-pages or interfaces of website 131 and may be navigable by computing device 110. In this regard, website 131 (e.g., as a domain of multiple webpages) and/or the individual webpages of website 131 may utilize cookies 133, such as browser cookies or other computer cookies that may be transmitted to be stored or placed client-side and/or on-device for different functionalities with a web browser.

Cookies 133 may include classifications 134, which identify the type and/or usage of cookies 133, such as essential browser cookies (e.g., those that are required for desired webpage functionality or for services requested/required between the user and the website) and/or nonessential browser cookies (e.g., those that provide benefits to users and/or entities when providing and/or rendering website data 132 for website 131 on computing devices, but not required for the requested service). In this regard, nonessential browser cookies may also be broken down into sub-categories including functional cookies, marketing cookies, or performance-based cookies. As such, user consents may dictate allowable transmissions and/or placements of cookies 133 based on classifications 134. Further, classifications 134 may be added or appended to cookie data, such as in a data string or other indication of a cookie classification in the data of cookies 133, so that a device receiving one or more of cookies 133 may validate and/or verify that the cookie being received and/or placed on the device is legitimate and complies with the corresponding user consent.

As such, to control computer and/or browser cookie transmissions of cookies 133 to and/or placements on different computing devices, such as computing device 110, cookies 133 may be transmitted and/or placed utilizing cookie placement process 135 and in accordance with classifications 134 and user consents. Cookie placement process 135 may detect that computing device 110 is interacting with and/or accesses/navigates to website 131, such as by receiving call 123 (e.g., an API call or other network call) for website data 132. Attached to the call 123 may include consent data that indicates a user consent. As such, cookie placement process 135 may execute a string parser 136 to identify the consent data and parse the data for a data string. The data string may be parsed by string parser 136 to determine, in one or more data fields, the parameters of the user consent, such as the extent to which the user allows transmission and/or placement of cookies 133 to/on computing device 110 for use with browser application 120 and/or website 131. The parameters may therefore indicate the user consent of the usage of cookies 133 with computing device 110.

As such, string parser 136 may identify the parameters of the user consent from the fields of the attachment to call 123. The attachment may be found attached to and/or injected/inserted in a header of a message for call 123, such as a header of an API call message. Using the parameters, cookie placement process 135 may then determine one or more of cookies 133 to provide to computing device 110 based on permissions for the corresponding user consent. Determination of which ones of cookies 133 to transmit to and/or place on computing device 110 may be based on classifications 134, such as cookie classification data that indicates a classification and/or intended purpose or usage of cookies 133. The cookie classification data may therefore be correlated to the parameters for the user consent, and the corresponding ones of cookies 133 transmitted to computing device 110. When sending cookies 133 to computing device 110, cookie placement process 135 may generate, add, and/or update a data string and/or data fields in an existing data string with the corresponding ones of classification 134 of cookies 133 for verification of their intended purpose and/or usage and compliance with the user consent.

In some embodiments, determining which of cookies 133 are allowed to be placed on computer device 110 based on parameters for user consent (e.g., extent of the user consent for time, cookie usage, cookie functionality, etc.) may be inferred using one or more artificial intelligence (AI) models and/or AI processes, such as machine learning (ML) models, neural networks (NNs), or other types of AI models. For example, ML models and/or NNs may include deep NNs (DNNs), MLs, large language models (LLMs), generative AI models, or other AI models may be trained to correlate and/or infer cookie placement consent from user consents and classifications 134. Training may be performed using training data having data records that have columns or other data representations and stored data values (e.g., in rows for the data tables having feature columns) for the features. When building ML models and/or NNs, training data may be used to generate one or more classifiers and provide recommendations, predictions, or other outputs based on those classifications and an ML or NN model algorithm and architecture. The algorithm and architecture for the ML models and/or NNs may correspond to DNNs, ML decision trees and/or clustering, conversational AI models, LLMs, generative AI, and other types of AI, ML, and/or NN architectures. The training data may be used to determine features, such as through feature extraction and feature selection using the input training data. For example, DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input feature data and/or data records. Thus, when the ML models and/or NNs are used to perform a predictive analysis and output, the input data may provide a corresponding output based on the trained classifications.

By providing training data, the nodes in the hidden layer may be trained (adjusted) such that an optimal output (e.g., a classification) is produced in the output layer based on the training data. By continuously providing different sets of training data and/or penalizing the ML models and/or NNs when the outputs are incorrect, the ML models and/or NNs (and specifically, the representations of the nodes in the hidden layer) may be trained (adjusted) to improve its performance in data classifications and predictions. Adjusting of the ML models and/or NNs may include adjusting the weights associated with each node in the hidden layer. Once trained, input features may include parameters for user consents and classifications 134, and outputs may include corresponding predictions or inferences related to allowance of placements of cookies 133 on corresponding devices.

Additionally, website server 130 includes database 137. Database 137 may store various identifiers associated with website server 130. Cookies, user consents, and/or cookie management data may be stored by database 137. Although database 137 is shown as residing on website server 130 as a database, in other embodiments, other types of data storage and components may be used including cloud computing storage nodes, remote data stores and database systems, distributed database systems over network 140 and/or of a computing system associated with website server 130, and the like.

Website server 130 may include at least one network interface component 138 adapted to communicate computing device 110 and/or other devices, servers, and the like directly and/or over network 140. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

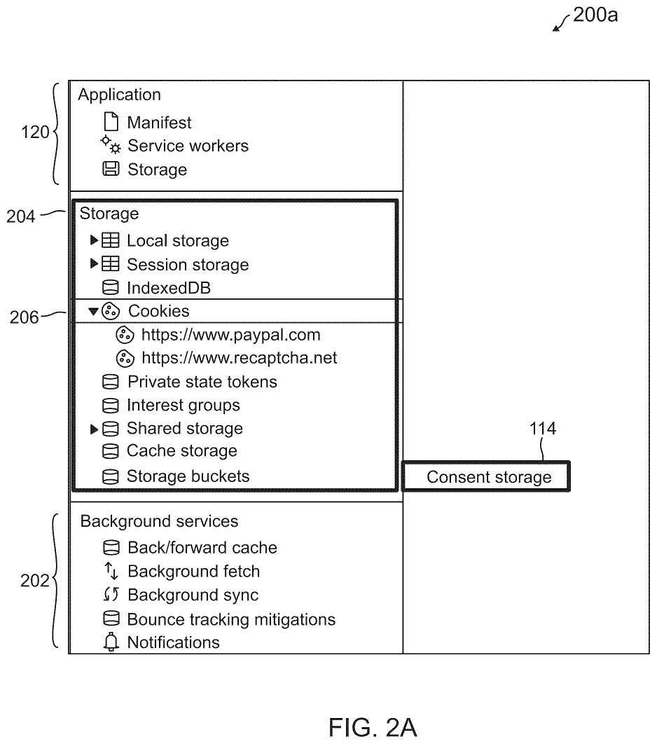

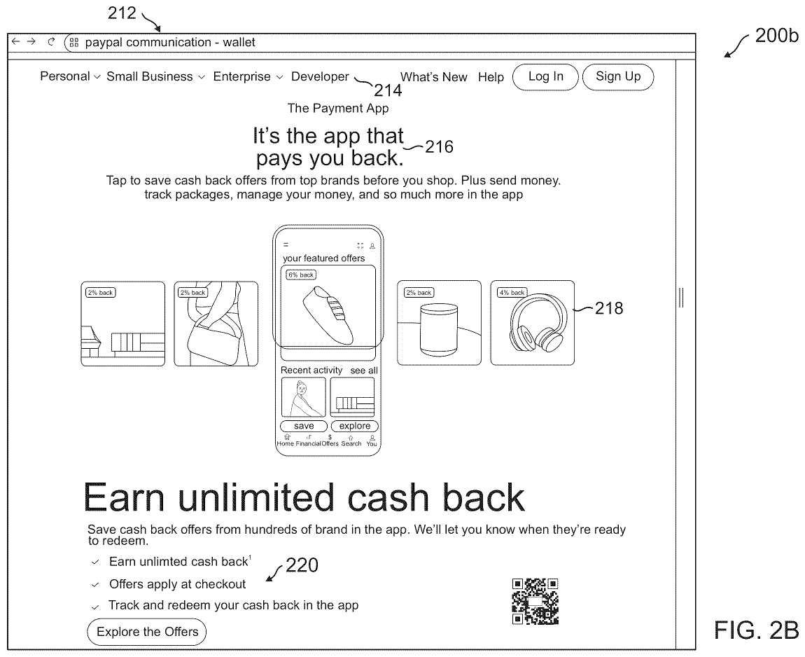

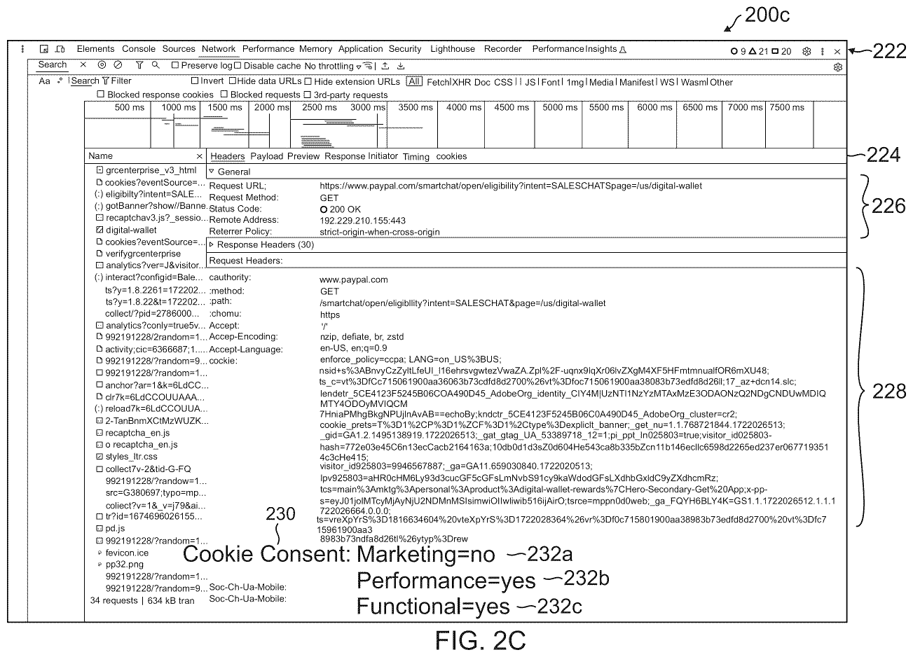

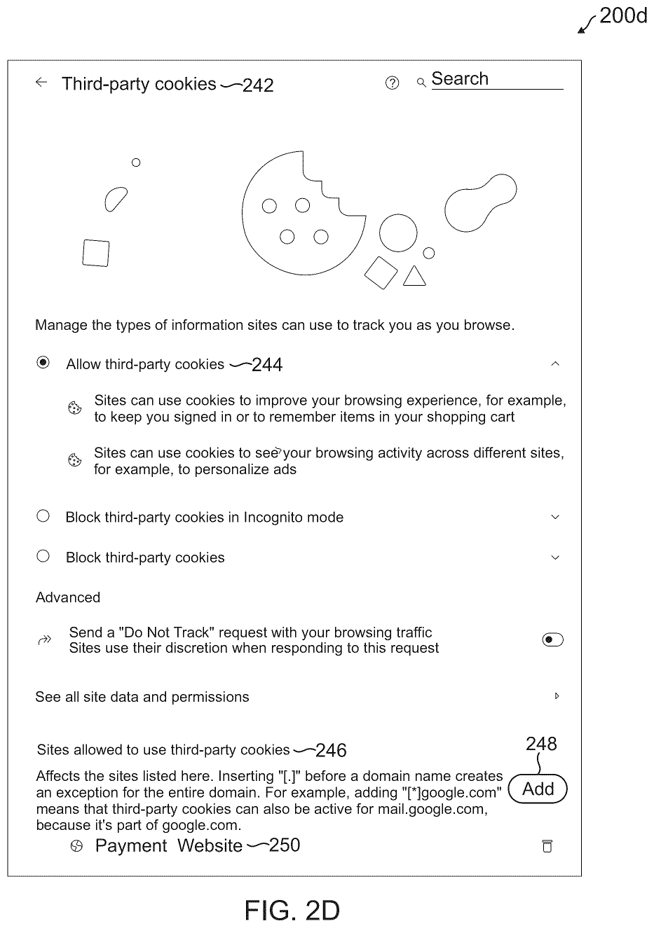

FIGS. 2A-2D are exemplary diagrams 200a-200d of device-side components that generate data strings and attachments for network calls to website hosts for website data with cookie consent permissions, according to an embodiment. Diagrams 200a-200d may include components referenced with regard to system 100 of FIG. 1, such as the components of website server 130 interacting with computing device 110 over network 140 to provide website 131 with cookies 133 in accordance with user consents 126. In this regard, diagrams 200a-200d shows representations of on-device components and interfaces for managing cookie placements through user consents.

In diagram 200a, an example of application components of browser application 120 is shown having consent storage 114. For example, browser application 120 may have application components identified in a user interface that may describe and/or identify the files, storages, and/or other shared data that forms the application and may be used to build and/or execute the application. This includes files such as an application manifest, as well as background services 202 for different background operations executable by browser application 120. For user consents for cookie placements, the application components further include a storage 204 having cookies 206, where placement of cookies 206 may be managed by consent storage 114.

During runtime of browser application 120, consent storage 114 may be accessed to determine user consents. The user consents may then be used to manage placement of cookies 206 in storage 204 on the computing device for use with browser application 120. Cookies 206 may include those cookies that are allowed based on the user consent, which may be identified by their corresponding classifications. As such, cookies 206 may be specifically stored in accordance with the user consents in consent storage 114 during runtime of browser application 120, and consent storage may be accessible during runtime to update user consents and enforce user consents on storage of cookies 206.

Referring now to diagram 200b, an exemplary webpage of website 131 is shown, which may include one or more webpage elements displayed based on browser cookies or other computer cookies transmitted to computing device 110 and used with browser application 120 for data rendering and/or tracking. In this regard, website 131 may be navigated to using a web address 212 for display of a webpage 214 in a user interface of browser application 120. A user consent may be determined based on web address 212, and when webpage data for webpage 214 is requested, the user consent may be attached to the network call requesting the data. Thus, data for webpage 214 may be received when web address 212 is navigated to, which may include one or more browser cookies provided to computing device 110 in accordance with the user consent.

Webpage 214 may include webpages elements 216, 218, and 220. However, rendering and/or display of webpages elements 216, 218, and 220 may require use of computer cookies. For example, webpage element 216 may include a banner that requires use of a functional cookie to render in a corresponding language, where a functional cookie corresponds to a type of nonessential browser cookies for language preferences of users. As such, the user consent may allow nonessential functional cookies, and webpage element 216 may be displayed. To display webpage elements 218, an essential cookie may be required to display a scrollable set of images with selectable elements. As such, the essential cookie for webpage element 218 may be transmitted to and placed on computing device 110 if the user consent allows, which enables proper rendering of webpage element 218. However, when even essential cookies are barred, a simple version of webpage 214 may be displayed without the required cookies for webpage element 218. Webpage element 220 may correspond to a marketing feature and require a marketing cookie, a type of nonessential cookie. As such, marketing cookies may only be used with computing device 110 when authorized by the user consent, such that if not authorized, webpage element 220 will not be shown or a generic, non-user specific element will be shown.

Referring now to diagram 200c, with webpage 214, a log file 222 is shown that may correspond to the network traffic log or other computing log of the corresponding calls and data from loading webpage 214 in FIG. 2B. As such, log file 222 may show different calls, events, data, and the like. In a log window 224 of log file 222, a user may view an API call 226, which indicates information for executing the API call to web address 212 and requesting data for loading of webpage 214. For API call 226, a request header 228 may include general header data and may indicate any cookies previously stored on the computing device. Additionally, a cookie consent 230 for placement of further cookies may be added to request header 228 based on the corresponding user consent for web address 212 and/or the corresponding website. Cookie consent 230 may be added to a data string, and may include parameters 232a-c, where parameters 232a-c indicate which nonessential cookies are allowable in webpage 214 in diagram 200b. For example, the user may have disallowed marketing cookies with parameter 232 a but allows performance and functional cookies with 232b and 232c.

Referring now to diagram 200d, a consent opt-in window 242 is shown for enabling or disabling third-party cookie placements on a computing device when the computing device accesses a webpage. A user may select an option 244 to allow third-party cookies but may further set restrictions on that allowance that restrict or limit which cookies can be placed on the computing device by websites for website functionalities and/or tracking. As such, a user may specify certain websites that are allowed to place cookies through website permissions 246, which allow a user to select an add website option 248 to enter one or more websites that are allowed to place cookies. An allowed website list 250 may show websites that are allowed to place cookies on the computing device and may be set in groups of websites. In addition, further options may be used to set limits on an amount of time that a cookie can be placed, as well as the cookie classification and/or type of cookie classification that is allowable to be placed on the computing device.

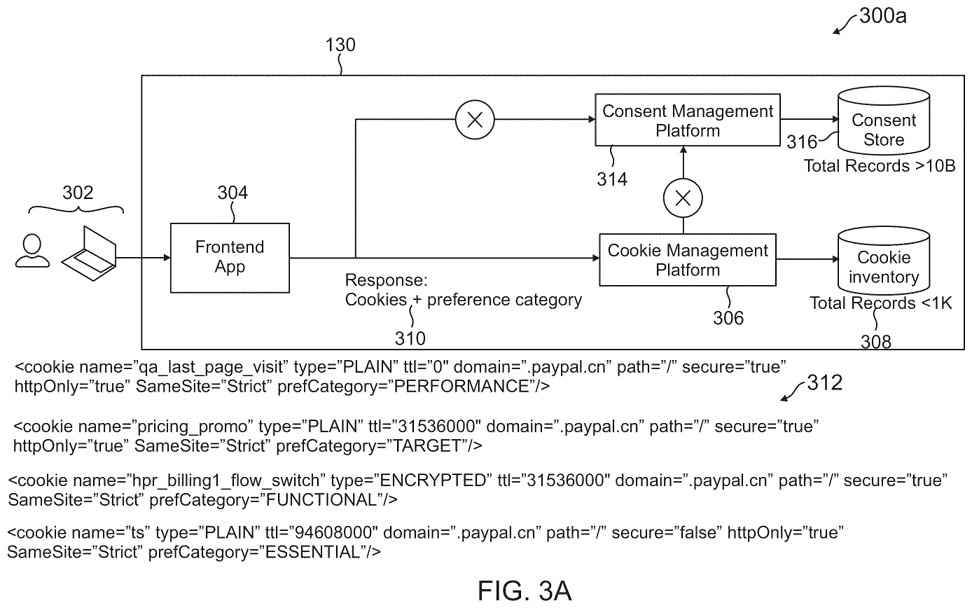

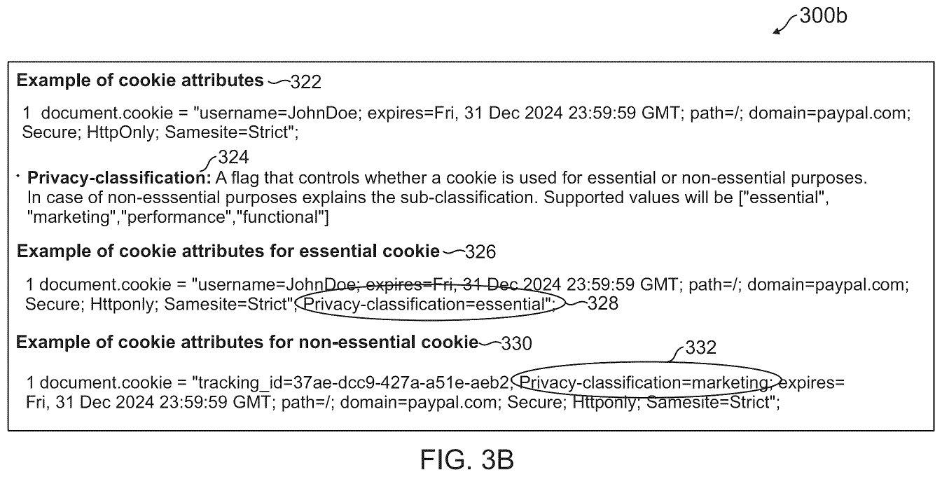

FIGS. 3A and 3B are exemplary diagrams 300a and 300b of server-side components and data that are usable process network calls having data strings and attachments for cookie consent permissions, according to an embodiment. Diagrams 300a and 300b may include components and data referenced with regard to system 100 of FIG. 1, such as the components of website server 130 interacting with computing device 110 over network 140 to provide website 131 with cookies 133 in accordance with user consents 126. In this regard, diagrams 300a and 300b shows representations of server-side components and data that are usable to receive user consents from attachments to network calls and provide computer cookies to devices in compliance with the user consents.

In diagram 300a, a user 302 may utilize a device to interact with a frontend application 304 of website server 130, such as a website application that may be used to provide website 131 over network 140. In this regard, when user 302 interacts with frontend application 304 through a device, the device may provide a user consent with a call to frontend application 304. The user consent may be used with a cookie management platform 306 to determine one or more cookies from a cookie repository 308 to provide to the device used by user 302 with website 131. This may be done through a response 310 that may include browser cookies or other computer cookies that have cookie classification data correlated to the parameters of the user consent. Response 310 may therefore include cookies 312 with their preference and/or classification categories, which may be updated and/or added to cookie data for those cookies. Frontend application 304 may provide response 310 to the device of user 302 when website data is requested and returned to the device for loading and display. As such, cookies 312 may be placed on the device in accordance with a user consent received from the device, and a lookup of preexisting user consents is not required, nor is a pop-up request or the like on the device for a consent opt-in for cookie usage and/or placement.

As shown in diagram 300a, website server 130 further includes a consent management platform 314 and a consent store 316. However, by managing the user consents for cookie placements on the device of user 302, it is shown in diagram 300a that communications and calls to consent management platform 314 is not required by frontend application 304 and/or cookie management platform 306. As such, consent store 316 is not required to perform a consent opt-in lookup of a user consent for user 302, and consent management platform 314 may instead provide cookies 312 based on a received user consent in a network call without causing unnecessary pop-up and/or requests to be presented to user 302.

Diagram 300b shows a more detailed example of cookies 312 with cookie attributes 322 that may be correlated to parameters of user consents and used for cookie placement and verification. In diagram 300b, cookie attributes 322 are shown, which may correspond to cookie classification data used to classify cookies and correlate cookies to parameters for user consent, such as allowable cookie classifications, allowable functionalities of cookies, and the like. In this regard, cookie attributes 322 may be a portion of a data string or the like for a computer cookie and may include a privacy classification 324 that classifies whether the cookie is used for essential or nonessential purposes. For essential cookies, an essential cookie classification attribute 326 is shown that includes a field having an essential classification 328 in the data string for the cookie shown. However, with nonessential cookies, a nonessential cookie classification attribute 330 allows for designation of nonessential classification 332 with a type of nonessential cookie classification, such as marketing, functional, performance, or the like.

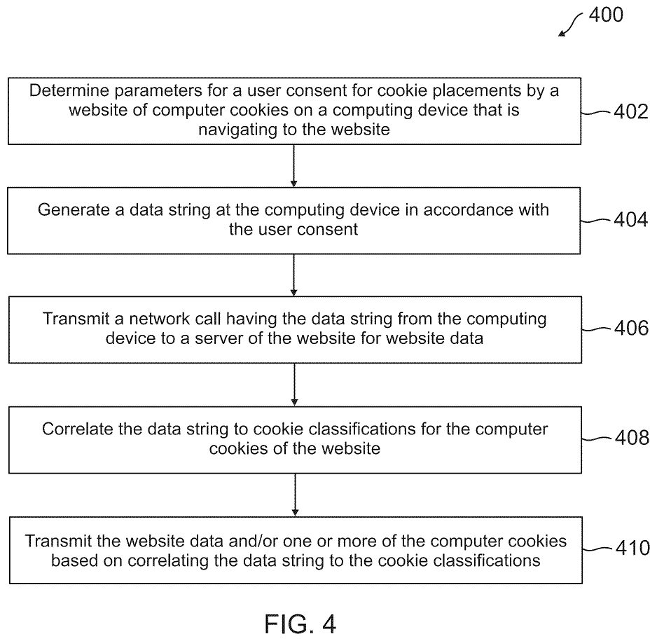

FIG. 4 is a flowchart 400 for on-device management of computing cookie placement for enforcement of user consents, according to an embodiment. Note that one or more steps, processes, and methods described herein of flowchart 400 may be omitted, performed in a different sequence, or combined as desired or appropriate.

Initially, at a step 402 of flowchart 400, parameters are determined for a user consent for placements by a website of computing cookies on a computing device that is navigating to the website. Computing device 110 may interact with website server 130 via an application that navigates to and attempts to access and load website 131. As such, a call 123 may be generated and/or transmitted to load website 131 in browser 121 of browser application 120. When transmitting call 123, one or more of user consents 126 may be transmitted as well to enforce user consents on data privacy and tracking through computer cookies, such as browser cookies that may be used with browser 121. As such, cookie manager 125 may perform a website lookup of user consents 126 from library 116 in consent storage 114 using an identifier, address, or other information for website 131. The parameters for the user consent may be determined from user consents 126, which may correspond to the extent of cookie placement authorization and consent including allowed cookie classifications (e.g., allowed essential cookies and/or allowed nonessential cookies including the type of the allowed nonessential cookies).

At step 404, a data string is generated at the computing device in accordance with the user consent. Once the user consent(s) and parameter(s) for allowable cookie placements are determined, cookie manager 125 may execute string generator 127 to generate and/or configure fields and parameters 128 in a data string that is to be attached to call 123 when transmitted to website server 130. As such, string generator 127 may create or generate a data string for website 131 to instruct website server 130 what cookies are allowed or disallowed by the corresponding user consent. The parameters may be used to convey the extent of the user consent, such as whether any cookies are allowed (e.g., an allowed essential cookie consent) and/or whether there are allowed nonessential cookies and their corresponding type of cookie classification.

At step 406, a network call having the data string from the computing device is transmitted to a server of the website for website data. Call 123 having a data string attached or inserted/injected (e.g., as data embedded in a header of a message or the like) may be transmitted from computing device 110 to website server 130. Call 123 may correspond to an API call or other network call/request for website data 132, and therefore may request a response from website server 130 that may cause loading of website 131 in browser 121 of browser application 120. Website server 130 may then receive call 123 that includes an attachment, message header with embedding or injected data, or the like, where call 123 may correspond to a network call to access and load website data 132 in browser 121 of browser application 120.

At step 408, the data string is correlated to cookie classifications for the computing cookies of the website. Cookie placement process 135 may utilize string parser 136 to parse the parameters for the user consent from the data string attached to call 123, such as the consent data that may be attached to or inserted in a header of call 123. After parsing the parameters from the data string, the parameters may be correlated to classifications 134 of cookies 133, which allows for determination of one or more of cookies 133 that are allowed to be transmitted to and/or placed on computing device 110 for use with browser 121 when accessing website 131.

At step 410, the website data and/or one or more of the computing cookies is transmitted based on correlating the data string to the cookie classifications. Cookies 133 may be selected based on the parameters of the user consent and classifications 134 of cookies 133, such as essential cookies, nonessential cookies, performance-based cookies, functional cookies, marketing cookies, or the like. Further, cookies and/or cookie data may be updated and/or configured with a data string indicating their classification, such as a corresponding identifier or other information of the classification of that cookie for use with verifying compliance with the user consent. Website server 130 may then transmit corresponding ones of cookies 133 to computing device 110, which may be received, stored, and/or placed on computing device 110 based on the user consent, which may further include a length of time before the cookie expires, is deleted, or otherwise is no longer valid on computing device 110.

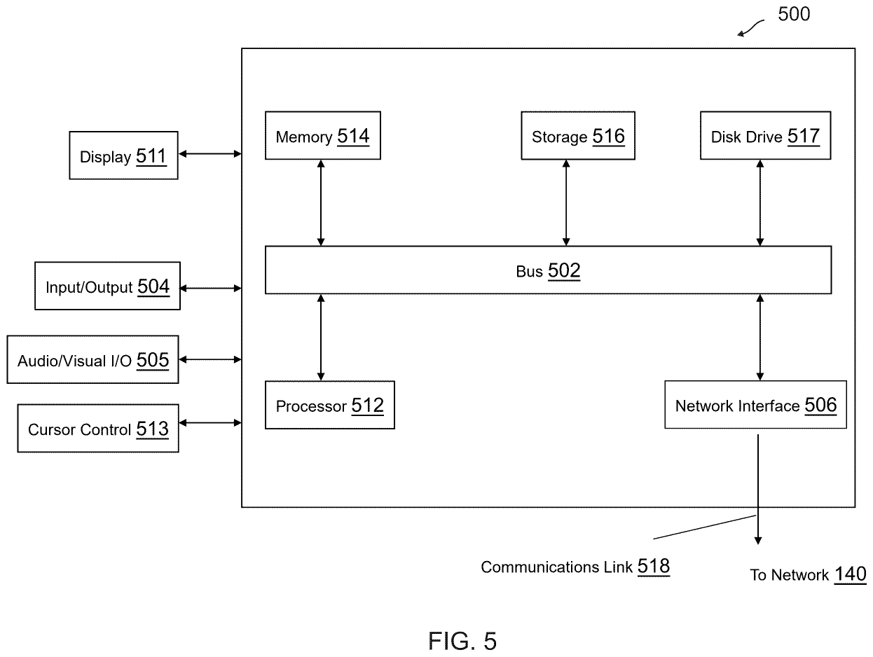

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving, from a computing device at a server, a network call for website data for a website being accessed by a web browser of the computing device;
identifying consent data attached to the network call by the web browser based on call data for the network call, wherein the consent data comprises a data string associated with a user consent for a placement of a browser cookie on the computing device, and wherein the browser cookie places data utilized with the website on the computing device;
parsing the data string in the consent data for the user consent, wherein the data string includes one or more fields indicating one or more parameters of the user consent that allow the placement of the browser cookie;
correlating cookie classification data for the browser cookie utilized with the website to the one or more parameters of the user consent from the data string; and
determining whether to transmit the browser cookie to the computing device based on the correlated cookie classification data.

2. The method of claim 1, wherein the network call comprises an application programming interface (API) call to an API associated with the website, and wherein the consent data is included with the API call when the API call is received for a request from the web browser for website data for the website.

3. The method of claim 2, wherein the consent data is included with the API call by one of injecting the consent data into a header of the API call or attaching the consent data to header data in the header.

4. The method of claim 1, wherein the determining whether to transmit the browser cookie comprises determining that the user consent prohibits the placement of the browser cookie or the browser cookie corresponding to the website violates the one or more parameters, and wherein the method further comprises:
preventing the placement of the browser cookie on the computing device based on the user consent.

5. The method of claim 1, wherein the determining whether to transmit the browser cookie comprises determining that the placement of the browser cookie is allowed based on at least one of the user consent or the one or more parameters, and wherein the method further comprises:
transmitting the browser cookie to the computing device; and
determining whether an update to cookie classification data for the browser cookie is required based at least on the user consent.

6. The method of claim 5, wherein, prior to the transmitting the browser cookie to the computing device, the method further comprises:
configuring a data file corresponding to the browser cookie to include at least one data field comprising at least one attribute associated with at least one classification of the browser cookie.

7. The method of claim 6, wherein the at least one attribute comprises a first attribute indicating whether the browser cookie is of a first type or a second type and a second attribute indicating a privacy classification of the browser cookie.

8. The method of claim 1, wherein the one or more parameters indicate an allowance or a refusal of the placement of nonessential cookies, performance-based cookies, functional cookies, marketing cookies, or a combination thereof.

9. The method of claim 1, wherein the determining whether to transmit the browser cookie includes predicting, using an artificial intelligence (AI) model, whether the user consent authorizes the placement of the browser cookie based at least on the one or more parameters and the data utilized with the website that is placed on the computing device.

10. A system comprising:
a non-transitory memory; and
one or more hardware processors coupled to the non-transitory memory and configured to execute instructions to cause the system to:
identify a navigation to a website being requested in a web browser executing on the system;
determine a user consent indicating whether a placement of a browser cookie on the system by the website is allowed based on user consents stored in a consent library for the web browser;
generate a data string associated with the user consent, wherein the data string includes one or more fields indicating one or more attributes of the browser cookie that are authorized by the user consent;
attach the data string to a network call to be made to the website based on the navigation; and
transmit the network call with the attached data string to the website based on the navigation.

11. The system of claim 10, wherein the instructions are further executable to cause the system to:
receive information for the user consent; and
create a record of the user consent in the consent library, wherein the record is retained on the system for one or more uses with at least the website.

12. The system of claim 11, wherein the consent library comprises a plurality of records of different websites each having one or more parameters for an extent of a corresponding user consent corresponding to browser cookies by the different websites.

13. The system of claim 11, wherein the information includes one or more parameters for an extent of the user consent for the placement of the browser cookie.

14. The system of claim 13, wherein the one or more parameters comprise at least one of an allowance of essential cookies, an allowance of nonessential cookies, a type of allowed nonessential cookies, or a length of time of the placement of the browser cookie.

15. The system of claim 14, wherein the type of the allowed nonessential cookies comprises one of functional cookies, marketing cookies, or performance-based cookies.

16. The system of claim 10, wherein attaching the data string to the network call comprises adding or injecting the data string to a header of message corresponding to the network call.

17. The system of claim 10, wherein the instructions are further executable to cause the system to:
receive the browser cookie; and
check a cookie classification in a data string of the browser cookie for a compliance with the user consent.

18. A non-transitory machine-readable medium having stored thereon machine-readable instructions executable to cause a machine to perform operations comprising:
determining that a network call by a web browser on a computing device comprises consent data, wherein the consent data comprises a data string associated with a user consent for a usage of a browser cookie by the website with the computing device;
parsing the data string for the user consent, wherein the data string includes a parameter indicating an extent of the user consent for the usage of the browser cookie with the computing device;
determining the browser cookie that corresponds to the user consent based on the parsing and a plurality of different browser cookies for the website;
determining a cookie classification for the browser cookie; and
transmitting the browser cookie having the cookie classification to the computing device.

19. The non-transitory machine-readable medium of claim 18, wherein the cookie classification indicates whether the browser cookie is an essential cookie or a nonessential cookie.

20. The non-transitory machine-readable medium of claim 18, wherein the extent indicates whether nonessential browser cookies allowed by the parameter include performance-based cookies, functional cookies, marketing cookies, and wherein the extent further includes a length of time for the usage.
